(19) United States
(12) Patent Application Publication
(10) Pub. No.: US 2010/0192228 A1
(43) Pub. Date: Jul. 29, 2010

(54) DEVICE, METHOD AND PROGRAM PRODUCT FOR PRIORITIZING SECURITY FLAW MITIGATION TASKS IN A BUSINESS SERVICE

(75) Inventor: Eliav Levi, Even Yehuda (IL)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Packard Development Company, L.P.

(21) Appl. No.: 12/361,279

(22) Filed: Jan. 28, 2009

(51) Int. Cl. G06F 21/00

(52) U.S. Cl. 726/25

(57) ABSTRACT

A device, method, and program product for prioritizing security flaw mitigation tasks is provided. The device, method, and program product are configured to receive, at a risk analysis engine, one or more business service models from a configuration management database, wherein the one or more business service models each comprises a set of configuration items, and wherein the one or more business service models each indicate a type of configuration item and a connectivity of the configuration item. The set of configuration items are sent to a vulnerability assessment tool to obtain one or more vulnerability assessment scores for each configuration item within the set of configuration items. A risk score for each configuration item is then determined. In turn, a prioritized list of configuration items is output based on the risk score of each configuration item.

### CROSS-REFERENCE TO RELATED PATENT APPLICATIONS

U.S. patent application Ser. No. 11/250199, titled, “DEVICE, METHOD, AND PROGRAM PRODUCT FOR DETERMINING AN OVERALL BUSINESS SERVICE VULNERABILITY SCORE,” is incorporated herein by reference in its entirety.

### FIELD OF THE INVENTION

Various embodiments of the present application relate to reporting risks of an organization's IT infrastructure and prioritizing the reported risks so that the risks can be addressed by IT managers in order of importance. More particularly, various embodiments of the present application relate to a Risk Analysis Engine that scores business services by analyzing standard vulnerability assessment scores and business service models in order to determine risk scores for individual configuration items within various business service models. The Risk Analysis Engine is configured to prioritize the configuration items based on their risk scores.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application, and is not admitted to be prior art by inclusion in this section.

In today's technological environment, the complexity and connectivity between information technology (IT) assets are increasing and changing at a rapid rate. As such, dozens of new system vulnerabilities are found daily on critical and non-critical IT assets. Left undetected or improperly corrected, these vulnerabilities provide an open door for network attacks, which can devastate an organization's IT infrastructure. Automated vulnerability tools can provide extremely detailed information about an IT system's assets. However, there is a need for a system that can convert vulnerability data into actionable information. That information can assist IT managers in prioritizing remediation tasks for an IT system.

### SUMMARY OF THE INVENTION

According to one embodiment, a device for prioritizing security flaw mitigation tasks, includes a communication interface configured to receive one or more business service models from a configuration management database. The one or more business service models each comprises a set of configuration items and the one or more business service models each indicate a type of configuration item and a connectivity of the configuration item. A computer is configured to send the set of configuration items to a vulnerability assessment tool. The computer receives, from the vulnerability assessment tool, one or more vulnerability assessment scores for each configuration item within the set of configuration items. The computer determines a risk score for each configuration item based on the one or more vulnerability assessment scores for each configuration item, and outputs, electronically, a prioritized list of configuration items based on the risk score of each configuration item.

According to another embodiment, a method for prioritizing security flaw mitigation tasks includes receiving, at a risk analysis engine, one or more business service models from a configuration management database. The one or more business service models each comprises a set of configuration items and the one or more business service models each indicate a type of configuration item and a connectivity of the configuration item. The method further includes sending the set of configuration items to a vulnerability assessment tool, receiving, from the vulnerability assessment tool, one or more vulnerability assessment scores for each configuration item within the set of configuration items, determining a risk score for each configuration item based on the one or more vulnerability assessment scores for each configuration item, and outputting, electronically, a prioritized list of configuration items based on the risk score of each configuration item.

According to yet another embodiment, a computer-readable medium for prioritizing security flaw mitigation tasks, includes computer readable instructions, which when executed by a processor cause a device to receive, at a risk analysis engine, one or more business service models from a configuration management database. The one or more business service models each comprises a set of configuration items, and the one or more business service models each indicate a type of configuration item and a connectivity of the configuration item. The device is further configured to send the set of configuration items to a vulnerability assessment tool. The device receives, from the vulnerability assessment tool, one or more vulnerability assessment scores for each configuration item within the set of configuration items. The device determines a risk score for each configuration item based on the one or more vulnerability assessment scores for each configuration item, and outputs, electronically, a prioritized list of configuration items based on the risk score of each configuration item.

These and other features of various embodiments of the present invention, together with the organization and manner of operation thereof, will become apparent from the following detailed description when taken in conjunction with the accompanying drawings, wherein like elements have like numerals throughout the several drawings described below. However, the accompanying drawings of the preferred embodiments of the invention are for explanation and understanding only and should not be taken to be limitative to the invention.

### BRIEF DESCRIPTION OF THE DRAWINGS

FIG. 1 is an overview diagram of a system within which various embodiments of the present invention may be implemented.

FIG. 2 is a schematic representation of network elements, according to one embodiment.

FIG. 3 is a flow chart illustrating processes performed in accordance with various embodiments from the perspective of the Risk Analysis Engine depicted in FIG. 2.

FIG. 4 is an exemplary view of a graphical representation of a business service model, according to one embodiment.

FIG. 5 is an exemplary view of an exemplary output of the Risk Modeling Engine, according to one embodiment.

FIG. 6 is a view of an exemplary output of the Risk Modeling Engine, according to one embodiment.

### DETAILED DESCRIPTION

Embodiments of the disclosure will be described below with reference to the accompanying drawings. It should be understood that the following description is intended to describe exemplary embodiments, and not to limit the claimed subject matter.

Various embodiments of the present invention relate to a Risk Analysis Engine which enables business management to better understand the IT security environment of an organization. This Risk Analysis Engine enables business management to make more informed or strategic decisions based on the level of vulnerability and the business service associated with the vulnerability.

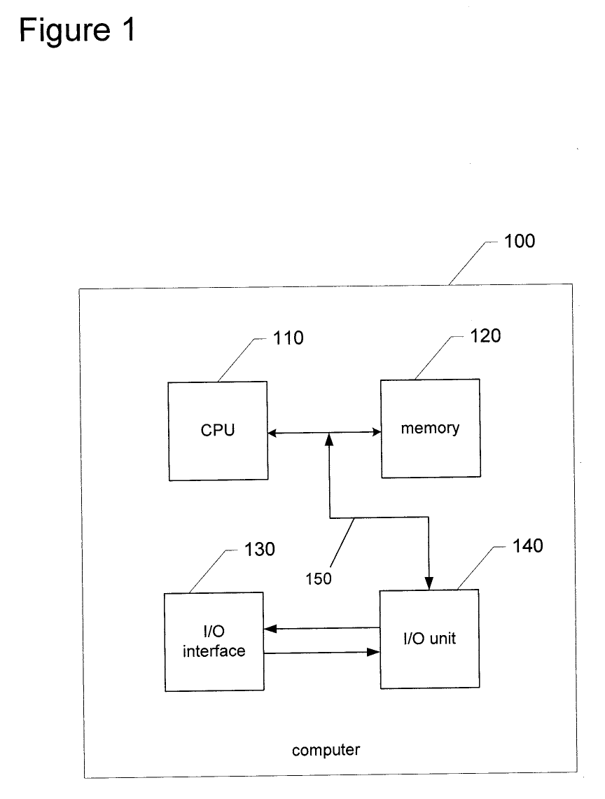

FIG. 1 is a block diagram of a system within which various embodiments of the Risk Analysis Engine may be implemented. An exemplary system for implementing the Risk Analysis Engine may include a computing device 100 in the form of a computer, including a processing unit (CPU) 110, a system memory 120, and a system bus 150 that couples various system components including the system memory to the processing unit. The computing device 100 may also include one or more interfaces 130, such as a display, keyboard, or mouse, electronically coupled to an input/output unit 140. The system memory 120 may include removable and non-removable storage devices including, but not limited to, Read Only Memory (ROM), Random Access Memory (RAM), compact discs (CDs), digital versatile discs (DVDs), etc.

Embodiments within the scope of the present invention also include computer-readable media, such as memory, for having computer-executable instructions or data structures stored thereon, also known as software. Such computer-readable media can be any available media, which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to store desired program code means in the form of computer-executable instructions or data structures, and which can be accessed by a general purpose or special purpose computer. Computer-executable instructions comprise, for example, instructions and data which cause a general purpose computer, special purpose computer, or special purpose processing device to perform a certain function or group of functions. Computer-executable instructions may also be properly termed “software” as known by those of skill in the art.

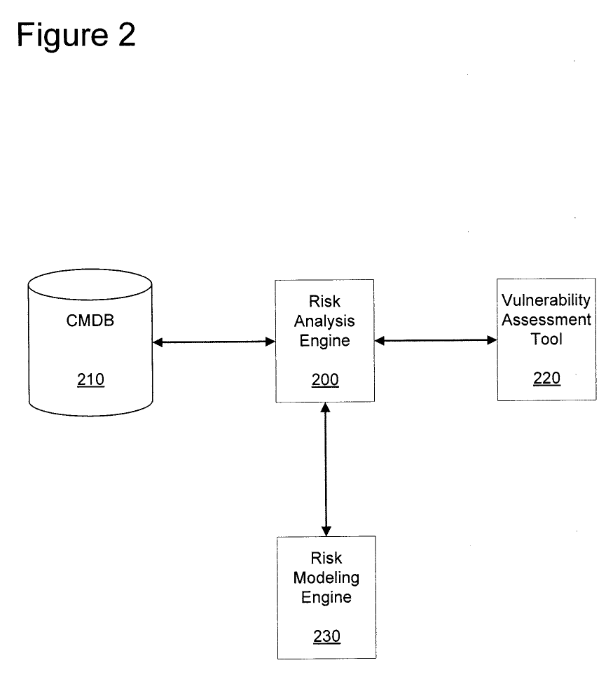

FIG. 2 is a block diagram for prioritizing security flaw mitigation tasks according to one embodiment. As illustrated, a Risk Analysis Engine 200 is electronically coupled to a configuration management database (CMDB) 210, a Vulnerability Assessment Tool 220, and a Risk Modeling Engine 230. Each of these elements contain one or more interfaces which enable the respective element to send and receive information to and from the other elements within the network or system. According to one embodiment, all of the above-described elements may be located in a single computing device or in the alternative may be located in separate distinct nodes. Furthermore, according to one embodiment, the Risk Analysis Engine 200, Vulnerability Assessment Tool 220 and Risk Modeling Engine 230, may be embodied in a single computing device and communicate with a separate or remote CMDB 210.

The CMDB 210 is intended to denote a particular type of repository in accordance with the Information Technology Infrastructure Library (ITIL) definition published online at the ITIL library. CMDB “[s]tands for Configuration Management Database. It contains all information about the users, assets, incidents, problems, etc.” See ITIL—The ITIL Glossary, available at http://www.itlibrary.org/index.php?page=The_ITIL_Glossary. More specifically, the CMDB 210 is configured to store business service models each comprising a set of configuration items (CIs) or IT assets associated with the particular business service.

As used herein, the terms “business services model” or “business service” are in accordance with the ITIL definition of business process/services, and thereby denote business activities undertaken by an organization in pursuit of a common goal. Typical business services include receiving orders, marketing services, selling products, delivering services, distributing products, invoicing for services, accounting for money received. A business service usually depends upon several business functions for support, e.g., IT, personnel, and accommodation. A business service rarely operates in isolation, i.e., other business services will depend on it, and it will depend on other services.

A business service model may include other business service models within itself (i.e., sub-sets). For example, a business service model related to “online banking” may include three business service models related to “account services,” “transferring funds,” and “bill payment.” Accordingly, business service models may be represented graphically in a “tree” configuration, wherein a single business service model may include a plurality of other business service models, and wherein each business service model comprises a set of CIs. For example, if the business services model is for “Customer Service,” a set of CIs associated with the Customer Service technology infrastructure would be correlated with the business services model for Customer Service.

The terms “IT asset” and “CI” or “CIs” are used interchangeably throughout the disclosure and are intended to denote any IT asset/infrastructure component of an organization (in accordance with the ITIL definition). A CI may be implemented with hardware and/or software. For example, a CI may be a server, computer, software application, router, network connection, private branch exchange (PBX), automatic call distributor (ACD), printer, desktop, telephone, or any other technological asset associated with an organization.

The Risk Analysis Engine 200 is configured to query the CMDB 210 in order to receive business service models. The query may be a general query requesting all of the business service models stored in the CMDB 210, or may be a specific query requesting specific business service models related to business sectors, a particular organization, etc. For example, a query may comprise a business service name. The CMDB 210 responds to the query with a reply message comprising one or more business service models.

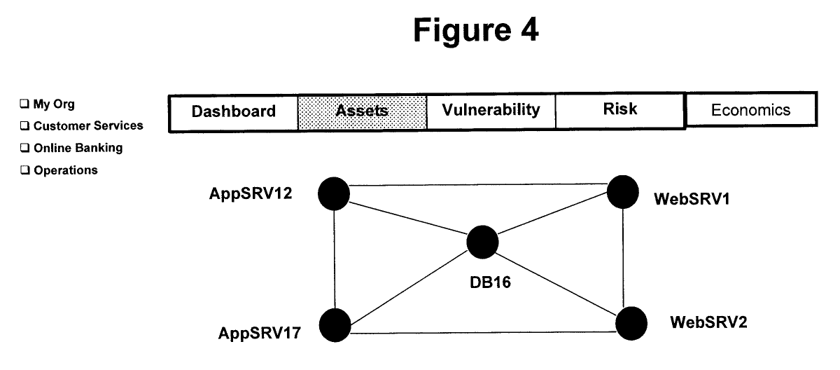

The Risk Analysis engine is configured to output information to a user concerning information related to assets, vulnerability, risk and economics. FIGS. 4-6 are exemplary embodiments of how the Risk Analysis Engine 200 presents information to a user. The graphical user interface (GUI), shown in FIGS. 4-6, allows a user to select various views that display information related to specific data accessible via the Risk Analysis Engine, e.g., assets, vulnerability, risk and economics. According to one embodiment, a selection bar is provided at the top of each GUI for allowing the user to select information. In FIGS. 4-6, the shaded box in the selection bar indicates which type of information is being displayed.

An exemplary graphical representation of information representing a business service model is illustrated in FIG. 4. Specifically, assets associated with a business service of interest (the relevant data having been retrieved from the CMDB 210) is being displayed in response to a user selection of “Assets.” As shown, the business service model indicates all of the CIs or assets (Application servers—AppSRV12 and AppSRV17, Web servers—WebSRV1 and WebSRV2, and database—DB16) associated with a particular business service. As further shown, the business service model also depicts all of the connections (logical and physical) between all of the CIs associated with the particular business service. The information depicted in this graphical representation of the business service model may be provided from the CMDB 210 to the Risk Analysis Engine 200 in various forms. For example, a list of CIs and associated relationships may be provided to the Risk Analysis Engine 200 via a XML description or text document. In addition, each business service model may indicate a relationship between the various CIs within the set of CIs. As used herein, the term relationship is used to denote physical and/or logical relationships between the CIs.

After the Risk Analysis Engine 200 has received the business service models from the CMDB 210, the Risk Analysis Engine 200 is configured to send one or more sets of CIs (each set associated with a business service model) to the Vulnerability Assessment Tool 220 electronically coupled therewith. The Vulnerability Assessment Tool 220 may be a security tool or compliance management tool which assesses risks associated with the one or more CIs. The Vulnerability Assessment Tool 220 is configured to detect all of the vulnerabilities and create a list of vulnerabilities for each CI. In addition, the Vulnerability Assessment Tool 220 is configured to determine a score for each vulnerability, thereby creating a vector of scores (e.g., V₁, V₂, V₃ . . . Vₙ) for each CI. In one embodiment, the score may be based on a Common Vulnerability Scoring System (CVSS). The CVSS is an industry standard for assessing the severity of computer system security vulnerabilities. In other embodiments, the score may be computed using a scoring system which assigns vulnerability scores to IT assets based on a custom or general scoring algorithms.

Once the Vulnerability Assessment Tool 220 has calculated the vector of vulnerability scores (e.g., V₁, V₂, V₃ . . . Vₙ) for a CI, the Vulnerability Assessment Tool 220 sends a vector of vulnerability scores (CVSS scores) for the CI back to the Risk Analysis Engine 200. The Risk Analysis Engine 200 takes the vector of scores (e.g., V₁, V₂, V₃ . . . Vₙ) and determines a single vulnerability score (S_{CIx}) for the CI. For example, the single vulnerability score (S_{CIx}) for a particular CI may be based on the following function: S_{CIx}=F₁(V₁, V₂, V₃ . . . Vₙ); where S_{CIx} is the single vulnerability score for the particular CI, F₁ is a function, and V₁-Vₙ are the vector of vulnerability scores for the particular CI received from the Vulnerability Assessment Tool 220. With regard to F₁, an exemplary function may be an average function wherein S_{CIx} equals the average of vulnerability scores (V₁, V₂, V₃ . . . Vₙ). For example, if there were three vulnerability scores for a particular CI, S_{CIx} would equal the sum of the three vulnerability scores divided by three. However, this function should not be seen as limiting, as other functions may be used to determine the single vulnerability score (S_{CIx}) for the particular CI.

Once the single vulnerability score (S_{CIx}) is determined for the CI, a weight (W_{CIx}) is determined for the CI. The weight (W_{CIx}) for each IT asset (CI) may be determined based solely on its technology-type, based solely on its topology-type, or based on a combination of its technology-type and topology-type, to name a few possibilities.

If the weight is based solely on the technology type, a weight (W_{CIx}) is assigned to the CI based on the type of asset. For example, a “database” may receive a weight of 1.5, a “web server” may receive a weight of 1.0, and a “user computer” may receive a weight of 0.2. According to one embodiment, each technology type may have a minimum weight associated with the IT asset (CI) and an administrator can adjust the weights (above the minimum) as desired.

Alternatively, if the weight is based solely on topology-type, the weight (W_{CIx}) may be determined based on the number of network connections (logical and/or physical) associated with the IT asset. In other words, a network asset that is more “popular” may receive a higher weight. For example, a frequently accessed server with a plurality of network connections (logical and/or physical) may receive a weight of 1.5, whereas a server with few network connections may receive a weight of 0.5.

Still further, the weight (W_{CIx}) may be determined based on both the technology-type and topology-type. In this determination, a weight based on technology-type and another weight based on topology-type are determined. Subsequently, the two weights are combined to form a single weight. In one embodiment, the single weight may be determined by multiplying the topology-type weight by the technology-type weight. Alternatively, an average of the topology-type weight and the technology-type weight may be employed. In addition, other functions/method are contemplated to determine the weight for a particular CI. Therefore, the example provided herein should not be seen as limiting.

The above-discussed process is conducted for each CI received from the Vulnerability Assessment Tool 220. Thus, in one embodiment, based on the vector of scores received, the Risk Analysis Engine 200 determines a single vulnerability score (S_{CIx}) and a single weight (W_{CIx}) for each CI associated with the business service.

The Risk Analysis Engine 200 is configured to calculate a risk score (R_{CIx}) for each CI within a business service model with the single vulnerability score (S_{CIx}) and single weight (W_{CIx}) for the particular CI. According to one embodiment, the risk score is calculated with the following equation: R_{CIx}=W_{CIx}*(S_{CIx}). According to another embodiment, the risk score is calculated as follows: R_{CIx}=W_{CIx}*(S_{CIx})+C, wherein C=the business criticality of the business service to which the CI belongs. Having calculated risk scores for each CI, the Risk Analysis Engine 200 is configured to output a prioritized list of CIs based on their risk scores (R_{CIx}) to the Risk Modeling Engine 230.

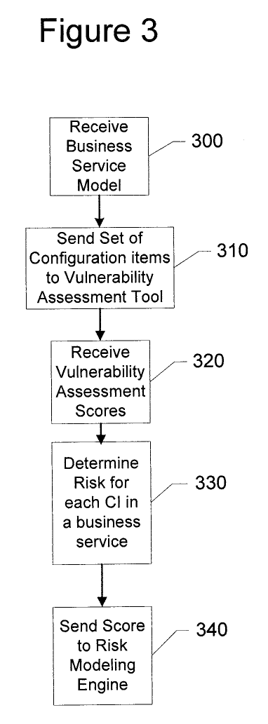

FIG. 3 is a simplified flow chart illustrating the above-described processes. At step 300, the Risk Analysis Engine 200 receives one or more business service models from one or more CMDBs. For example, the Risk Analysis Engine 200 may receive a business service model for “operations,” “online banking,” and “customer service.” Each business service model comprises a set of CIs.

At step 310, the Risk Analysis Engine 200 sends each set of configuration items (CIs) to the Vulnerability Assessment Tool 220. As discussed above, the Vulnerability Assessment Tool 220 provides one or more CVSS scores for each CI. After computing the scores, the Vulnerability Assessment Tool 220 sends the scores back to the Risk Analysis Engine 200. There will generally be a plurality of scores in the form of a vector sent from the Vulnerability Assessment Tool 220 to the Risk Analysis Engine 200 for each CI.

At 320, the Risk Analysis Engine 200 receives the vector of scores for each CI from the Vulnerability Assessment Tool 220. At 330, the Risk Analysis Engine determines a risk score (R_{CIx}) for each CI in a business service model based on the above-discussed algorithms.

The above-discussed process can be conducted for each business service model. As shown in step 340, once a risk score is determined for each CI in each business service model, this information is sent to a Risk Modeling Engine 230, which is electronically coupled to the Risk Analysis Engine 200.

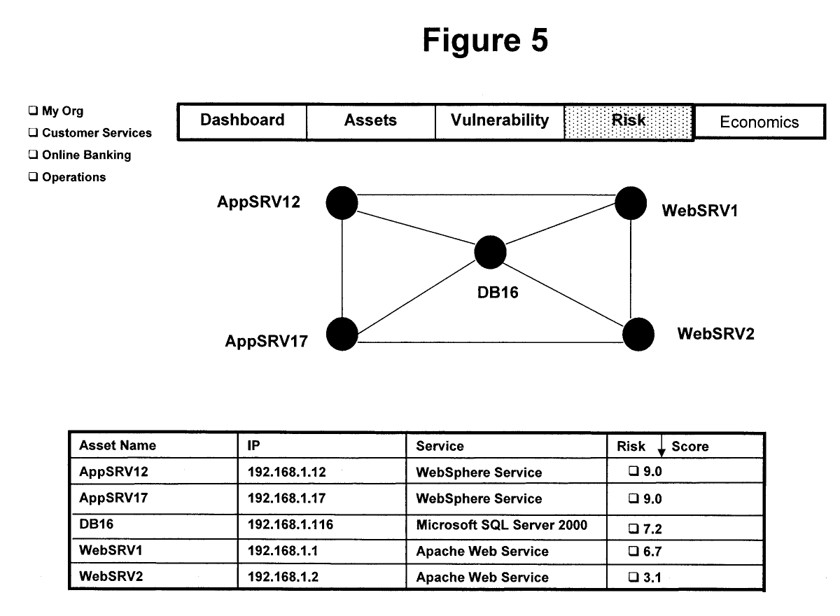

FIG. 5 is an exemplary output generated by the Risk Modeling Engine 230, given the risk scores (R_{CIx}) for CIs in a particular business service model. FIG. 5 illustrates a topology view for a specific business service. This view enables a user to view a prioritized list of the CI name, the IP address, and the service arranged by a calculated risk score (R_{CIx}) (on an asset by asset basis). In addition, this view depicts the connectivity between the various CIs. Based on FIG. 5, according to one embodiment, an IT manager can easily determine that the asset named AppSRV12 with a risk score of 9.0 should be serviced first.

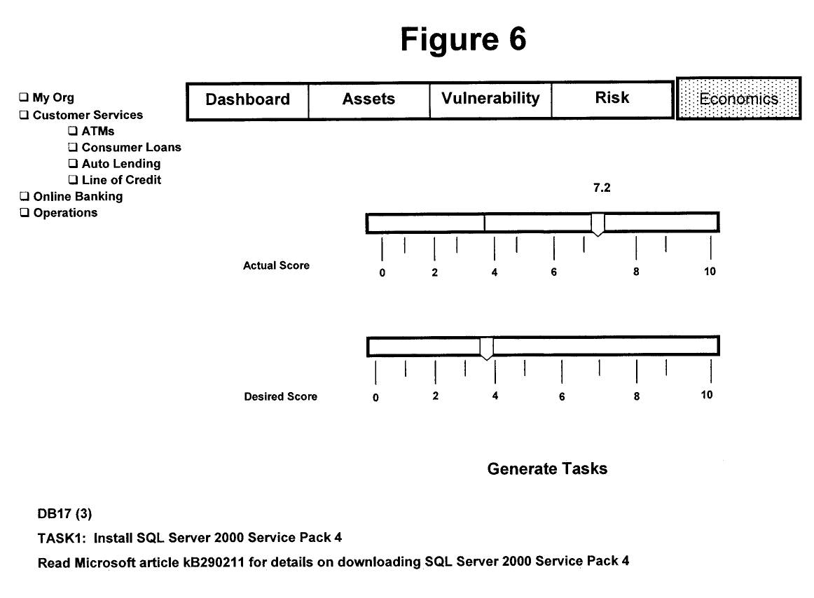

FIG. 6 illustrates an “economics” view of a specific business service. This view shows the task for every CI in order to decrease the risk to a desired level. For example, if a Cl's actual risk score is 7.2, and the user desires the score to be a 3.8, the “economics” view indicates which tasks need to be conducted in order to lower the risk from a 7.2 to a 3.8. For example, the “TASK1” field in FIG. 7 indicates that the risk score will be reduced from a 7.2 to a 3.8 if “SQL Server 2000 Service Pack 4” is installed in DB17, wherein DB17 is a CI within the “Auto Lending” business service. In addition, “TASK1” provides help or instructions on how to download this product by stating: “Read Microsoft article KB290211 for details on downloading SQL Server 2000 Service Pack 4.”

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

It should also be noted that although the flow charts provided herein show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the invention.

The foregoing description has been presented for purposes of illustration and description. It is not intended to be exhaustive or to be limited to the precise form disclosed, and modifications and variations are possible in light of the above teaching or may be acquired from practice of the disclosure. The above-referenced embodiments were chosen and described in order to explain the principles of the disclosure and as a practical application to enable one skilled in the art to utilize the disclosure in various embodiments, and with various modifications, are suited to the particular use contemplated. It should be understood that the following description is intended to describe exemplary embodiments, and not to limit the claimed subject matter.

What is claimed is:

1. A device for prioritizing security flaw mitigation tasks, comprising:
a communication interface configured to:
receive one or more business service models from a configuration management database, wherein the one or more business service models each comprises a set of configuration items, and wherein the one or more business service models each indicate a type of configuration item and a connectivity of the configuration item;
a computer configured to:
send the set of configuration items to a vulnerability assessment tool;
receive, from the vulnerability assessment tool, one or more vulnerability assessment scores for each configuration item within the set of configuration items;
determine a risk score for each configuration item based on the one or more vulnerability assessment scores for each configuration item; and
output, electronically, a prioritized list of configuration items based on the risk score of each configuration item.

2. The device of claim 1, wherein the computer is configured to output, electronically, the prioritized list of configuration items based on the risk score of each configuration item to a Risk Modeling Engine.

3. The device of claim 1, wherein the device is configured to calculate a single vulnerability score for each configuration item based on the one or more vulnerability assessment scores received from the vulnerability assessment tool.

4. The device of claim 1, wherein the device is configured to determine the risk score for each configuration item based, in part, on determining a weight for each configuration item.

5. The device of claim 4, wherein determining the weight for each configuration item comprises determining the weight based on a type of technology associated with the configuration item.

6. The device of claim 4, wherein determining the weight for each configuration item comprises determining the weight based on logical or physical connectivity of a configuration item.

7. The device of claim 1, wherein the device is configured to determine the risk score for each configuration item based, in part, on the business criticality of the business service model to which the configuration item belongs.

8. A method for prioritizing security flaw mitigation tasks, comprising:
receiving, at a risk analysis engine, one or more business service models from a configuration management database, wherein the one or more business service models each comprises a set of configuration items, and wherein the one or more business service models each indicate a type of configuration item and a connectivity of the configuration item;
sending the set of configuration items to a vulnerability assessment tool;
receiving, from the vulnerability assessment tool, one or more vulnerability assessment scores for each configuration item within the set of configuration items;
determining a risk score for each configuration item based on the one or more vulnerability assessment scores for each configuration item; and
outputting, electronically, a prioritized list of configuration items based on the risk score of each configuration item.

9. The method of claim 8, further comprising:
outputting, electronically, the prioritized list of configuration items based on the risk score of each configuration item to a Risk Modeling Engine.

10. The method of claim 8, wherein the single vulnerability score for each configuration item is calculated based on the one or more vulnerability assessment scores received from the vulnerability assessment tool.

11. The method of claim 8, wherein the risk score for each configuration item is based, in part, on determining a weight for each configuration item.

12. The method of claim 11, wherein determining the weight for each configuration item comprises determining the weight based on a type of technology associated with the configuration item.

13. The method of claim 11, wherein determining the weight for each configuration item comprises determining the weight based on logical or physical connectivity of a configuration item.

14. The method of claim 8, wherein determining the risk score for each configuration item is based, in part, on the business criticality of the business service model to which the configuration item belongs.

15. A computer-readable medium for prioritizing security flaw mitigation tasks, including computer readable instructions, which when executed by a processor cause a device to:
receive, at a risk analysis engine, one or more business service models from a configuration management database, wherein the one or more business service models each comprises a set of configuration items, and wherein the one or more business service models each indicate a type of configuration item and a connectivity of the configuration item;
send the set of configuration items to a vulnerability assessment tool;
receive, from the vulnerability assessment tool, one or more vulnerability assessment scores for each configuration item within the set of configuration items;
determine a risk score for each configuration item based on the one or more vulnerability assessment scores for each configuration item; and
output, electronically, a prioritized list of configuration items based on the risk score of each configuration item.

16. A computer-readable medium of claim 15, further causing a device to:
output the prioritized list of configuration items based on the risk score of each configuration item to a Risk Modeling Engine.

17. A computer-readable medium of claim 15, further causing a device to:
calculate a single vulnerability score for each configuration item based on the one or more vulnerability assessment scores received from the vulnerability assessment tool.

18. A computer-readable medium of claim 15, wherein determining the risk score for each configuration item is based, in part, on determining a weight for each configuration item.

19. The computer-readable medium of claim 15, wherein determining the weight for each configuration item comprises determining the weight based on a type of technology associated with the configuration item.

20. The computer-readable medium of claim 15, wherein determining the weight for each configuration item comprises determining the weight based on logical or physical connectivity of a configuration item.
